(19) United States
(12) Patent Application Publication
(10) Pub. No.: US 2025/0240078 A1
(43) Pub. Date: Jul. 24, 2025

(54) TECHNIQUES FOR DEFINING BEAM ASSOCIATION FOR EFFICIENT BEAM IDENTIFICATION AND PREDICTION

(71) Applicant: RAKUTEN SYMPHONY, INC., Tokyo (JP)

(72) Inventors: Subramanya CHANDRASHEKAR, Bangalore (IN); Raghavendra Madanahally RAMAKRISHNA, Bangalore, Karnataka (IN)

(73) Assignee: RAKUTEN SYMPHONY, INC., Tokyo (JP)

(21) Appl. No.: 18/698,491

(22) PCT Filed: Feb. 5, 2024
(86) PCT No.: PCT/US2024/014397

§ 371 Date: Apr. 4, 2024

(30) Foreign Application Priority Data
Aug. 17, 2023 (IN) 202341055263
Nov. 22, 2023 (IN) 202341055263

(51) Int. Cl. H04B 7/06; H04W 64/00

(52) U.S. Cl. CPC H04B 7/06952; H04W 64/003

(57) ABSTRACT

The present disclosure relates to techniques for defining beam association efficient beam identification and prediction. Particularly, the present disclosure transmits a set static beams by a network and based on that, predicting a set dynamic beams for a UE. The set of predicted beams are formed dynamically based on the location of the UE. During beam prediction configuration, transmitting a corresponding beam topology identifier to the UE that assist the UE, using a well-defined association between the set of transmitted and predicted beams, to predict one or more best beams from the set of predicted beams for communicating with a base station. In this way, the beam topology identifier defines a unique association between the set of transmitted beams and the set of predicted beams for efficient beam identification and prediction.

### REFERENCE TO RELATED APPLICATION(S)

This application claims the benefit of Indian Provisional Application No. 202341055263, entitled “TECHNIQUES TO DEFINE SET A-SET B BEAM ASSOCIATION FOR AI-ML BASED BEAM PREDICTION” and filed on Aug. 17, 2023, which is incorporated by reference herein in their entirety.

### TECHNICAL FIELD

The present disclosure relates to techniques for defining association between static beams e.g broadcast beams and dynamic beams e.g data beams for effective beam identification and prediction

### BACKGROUND

The following description includes information that may be useful in understanding the present invention. It is not an admission that any of the information provided herein is prior art or relevant to the presently claimed invention, or that any publication specifically or implicitly referenced is prior art.

In the field of beam management, Artificial Intelligence (AI)-Machine Learning (ML) based beam prediction forms one of the most crucial aspects. To be precise, beam management harnesses various algorithms and models to predict the optimal beam or antenna pattern for transmitting or receiving signals in a specific communication scenario. In a typical beam prediction procedure, at a user equipment side, beam prediction is done for a set of beams (e.g., Set A) based on measurement results of another set of beams (e.g., Set B). For the beam prediction procedure base station sends reference signals (RSs) corresponding to the beams from Set B such that Set B may or may not be a subset of Set A beams. UE then measures these Reference signals (RSs) i.e., measures the Set B beams and determines Set A beams based on the association with Set B beams (that is provided by Base Station). Accordingly, based on the measurement results from Set B and assistance information that may have been provided by the base station, the UE reports the best predicted beams within Set A beams. Here, assistance information may be required to indicate the association between Set A and Set B beams for effective and accurate beam prediction at the UE side. In the existing scenario (3GPP), where the association between the Set A and Set B beams is neither defined nor agreed, without assistance information, it is almost impossible for UE to make a prediction of the beams of Set A.

Therefore, there exists a need for defining and providing the Set A to Set B association from the base station to the UE so that UE may predict the beams of Set A and provide information relation to best beams to the base station for communication. It is also very important that the predicted beams of Set A are identified at the base station in a consistent manner and exactly as they are predicted at the UE.

### SUMMARY

The present disclosure overcomes one or more shortcomings of the prior art and provides additional advantages. Embodiments and aspects of the disclosure described in detail herein are considered a part of the claimed disclosure.

In one non-limiting embodiment of the present disclosure, a method is disclosed. The method comprises transmitting a set of static beams, set B by a network. Based on that transmitted set of static beams, predicting another set of beams, set A for a UE. The set of predicted beams (i.e. set A) are formed dynamically based on a location of the UE and hence could be data beams. The method further comprises transmitting, subsequently (i.e, during the beam prediction configuration), a corresponding beam topology identifier to the UE that assist the UE, using a well-defined association between the set of transmitted beams and predicted beams, to predict one or more best beams from the set of predicted beams A for communicating with a base station. The beam topology identifier defines a unique association between the set of transmitted beams and the set of predicted beams for efficient beam identification and prediction.

In another embodiment of the present disclosure, a base station is disclosed. The base station is configured to transmit at least a set of static beams. Based on the set of transmitted beams, the base station predicts a set of dynamic beams for a UE, wherein the set of predicted beams are formed dynamically based on a location of the UE and hence could be data beams. The base station is further configured to transmit, subsequently (i.e, during beam prediction configuration), a corresponding beam topology identifier to the UE that assist the UE, using a well-defined association between the set of transmitted and predicted beams, to predict one or more best beams from the set of predicted beams for communicating with the base station. The beam topology identifier identifies a well defined unique association between the set of transmitted beams and the set of predicted beams for efficient beam identification and prediction.

In yet another embodiment of the present disclosure, a non-transitory computer-readable storage medium storing executable instructions that, in response to execution, cause one or more processors of a base station to transmit a set of static beams (set B) by a network and based on that, predicting a set of dynamic beams (set A) for a UE, wherein the set of predicted beams are formed dynamically based on a location of the UE. The non-transitory computer readable media further comprises one or more instructions to transmit, subsequently (i.e, during beam prediction configuration), a corresponding beam topology identifier to the UE that assist the UE, using a well-defined association between the set of transmitted and predicted beams, to predict one or more best beams from the set of predicted beams for communicating with a base station. The beam topology identifier defines a unique association between the set of transmitted beams and the set of predicted beams for efficient beam identification and prediction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The features, nature, and advantages of the present disclosure will become more apparent from the detailed description set forth below when taken in conjunction with the drawings in which like reference characters identify correspondingly throughout. Some embodiments of system and/or methods in accordance with embodiments of the present subject matter are now described, by way of example only, and with reference to the accompanying FIGS., in which:

FIG. 1 depicts an existing environment 100 illustrating two sets of beams (set B and A, eg: broadcast and data beams) being transmitted from the BS, in accordance with the embodiments of the present disclosure;

FIG. 2 depicts a system 200 to define beam association for carrying out efficient beam identification and prediction, in accordance with the embodiments of the present disclosure;

FIG. 3 depicts a flow diagram illustrating a base station communicating with UE for carrying out beam prediction when the set of predicted beams (i.e., Set A) have been transmitted earlier to the UE at least once for the purpose of model training, for predicting one or more best beams in order to establish communication with the BS, in accordance with the embodiments of the present disclosure;

FIG. 4 depicts a flow diagram illustrating a base station communicating with UE for carrying out beam prediction when the set of predicted beams (i.e., Set A) have not been transmitted earlier to the UE for predicting one or more best beams in order to establish communication with the BS, in accordance with the embodiments of the present disclosure;

FIG. 5 illustrates a flowchart 500 of an exemplary method for defining association between predicted beams (i.e., Set A) and transmitted beams (i.e., Set B) for effective beam prediction at UE side, in accordance with the embodiments of the present disclosure;

FIG. 5A illustrates a sub-flowchart 500A of an exemplary method for generating beam topology identifier when the set of predicted beams (i.e., Set A) have not been transmitted earlier to the UE for predicting one or more best beams in order to establish communication with the BS, in accordance with the embodiments of the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be represented in a computer readable medium and executed by a computer or processor, whether such computer or processor is explicitly shown.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, “include”, “including”, or any other variations thereof, are intended to cover a non-exclusive inclusion, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

The terms like “at least one” and “one or more” may be used interchangeably or in combination throughout the description.

The terms like “base station”, “eNB” and “gNB” may be used interchangeably or in combination throughout the description.

The terms like “broadcast beams”, “control beams”, “transmitted beams” and “set B” may be used interchangeably or in combination throughout the description.

The terms like “data beams”, “predicted beams” and “set A” may be used interchangeably or in combination throughout the description.

Among various challenges faced in the process of accomplishing effective beam management, reliable and accurate beam prediction is of great importance. When AI/ML model is deployed at the UE side for carrying out beam prediction, then base station (BS) sends reference signals (RSs) to the UE corresponding to transmitted beams (set B, e.g broadcast beams). On receiving the set B beams, the UE determines the predicted beams (set A) based on the measurement results of set B beams and utilizes an Artificial Intelligence/Machine Learning (AI/ML) model to predict the one or more best beams within the determined set A beams. However, for the AI/ML model deployed at the UE side to effectively predict the best beam within the determined set A beams, assistance information may be required which may include the indication of the association between Set A and Set B beams. But yet there is no technique available in the art which defines the process of transmitting the association information from the BS to the UE.

To overcome the challenges as described in the foregoing paragraph, the present disclosure aims to provide a method and system to define the association information exchanged between the communicating BS and UE and transmit the same for carrying out the effective and accurate beam prediction at the UE. In particular, the association information of beams within Set A and beams within Set B helps the UE to get more information about the relationship between beams within Set A and beams within Set B. Accordingly, the UE may predict the beams of set A in a better way for effective beamforming. To achieve this, the present disclosure aims to disclose different embodiments for exchanging the association information between the BS and the UE. In an embodiment, the technique of exchanging the association information is disclosed when the set A beams have been transmitted earlier to the UE at least once for the purpose of model training, for predicting one or more best beams for communication with base station. In this embodiment, along with transmitted beams and their corresponding Reference Signals, the Base Station (BS) may also transmit the association information in the form of a beam topology identifier, to the UE for predicting one or more best beams from the set A of predicted beams for communicating with a base station. In another embodiment, the technique of exchanging the association information is disclosed when the set A beams have not been transmitted to the UE earlier to predicting one or more best beams for establishing the communication with the BS. In said embodiment, BS is enabled to configure the UE to transmit pre-defined beam identification related parameters to enable BS to correlate and identify the predicted beams. On receiving these parameters, BS is able to identify the exact beam predicted by the UE, though the predicted beam is dynamic in nature and it has not been beamformed earlier to prediction. Thus, the different embodiments recited in the present disclosure aim to define the association between the two set of beams (i.e., transmitted and predicted beams) and providing the corresponding beam topology identifier to the UE for robust beam prediction.

FIG. 1 depicts an existing environment 100 illustrating two sets of beams being transmitted from the BS. In this, a BS 102 has been configured to transmit two set of beams i.e., set A beams 106a, 106b and set B beams 104a, 104b, 104c. In one scenario, the two sets of beams may be transmitted in the spatial domain. In an embodiment, the set A beams 106a, 106b may be different from the set B beams 104a, 104b, 104c (i.e., set B beams are not subset of set A beams). In another embodiment, the set B beams 104a, 104b, 104c may be a subset of set A beams 106a, 106b. In another scenario, the two sets of beams may be transmitted in the temporal domain. In an embodiment, the set A beams 106a, 106b and set B beams 104a, 104b, 104c may be different (i.e., set B beams are not subset of set A beams). In another embodiment, the set B beams 104a, 104b, 104c may be a subset of set A beams 106a, 106b (i.e., set A and set B beams are not same). In yet another embodiment, the set A beams 106a, 106b may be same as that of set B beams 104a, 104b, 104c.

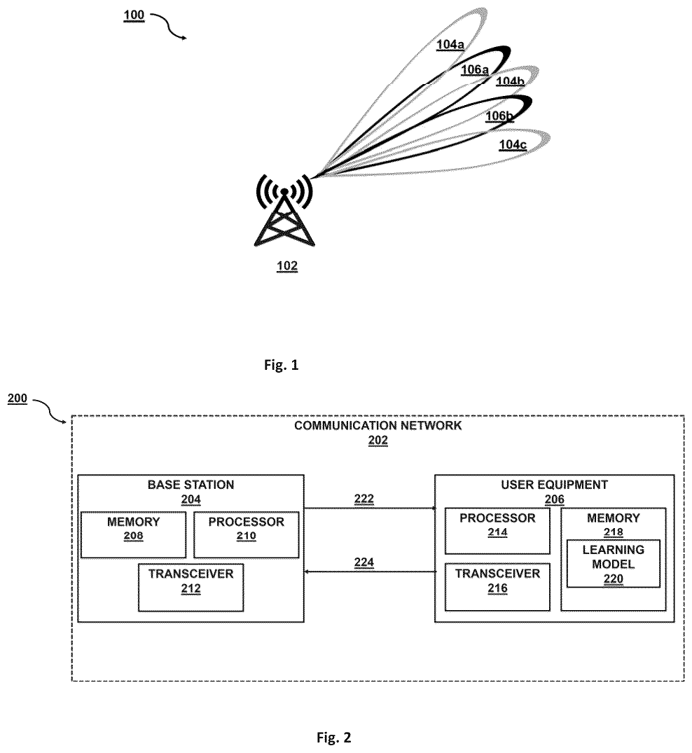

FIG. 2 depicts a system 200 for carrying out efficient beam identification and prediction. FIG. 2 discloses a communication network 202 that may be established between the BS 204 and UE 206 to effectively communicate with each other. The BS 204 may be configured such that it transmits a set of beams (set B, 222) to the UE 206. Along with the transmitted beams, the BS 204 may also be configured to transmit an assistance information to the UE so that the UE 206 may better predict the set of beams (Set A) based on the received set B beams.

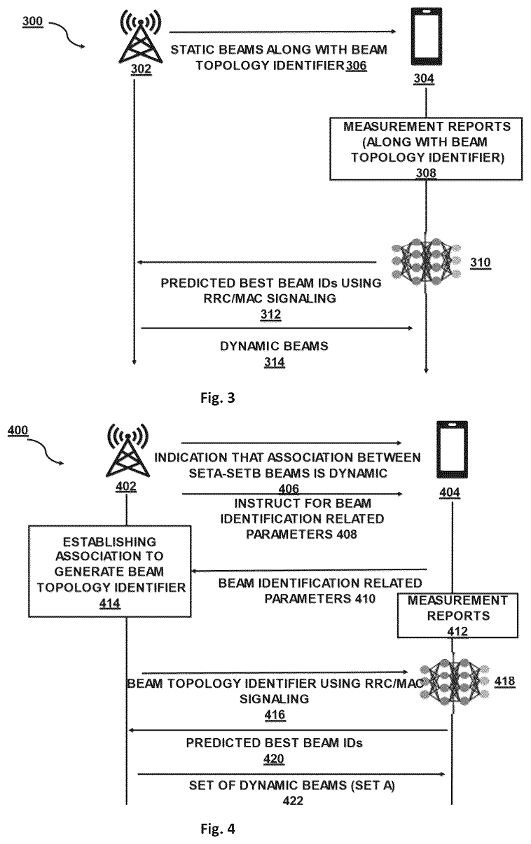

In an embodiment, this assistance information may include association information that indicates the relationship between the set of transmitted beams and the predicted beams to make the process of predicting the best beams within the set of data beams more robust for the UE. Particularly, to transmit the association information, the BS 204 may configure a beam topology identifier and transmit it to the UE 206 when AI-ML based beam prediction is configured. This beam topology identifier categorically defines the association between the corresponding set of transmitted beams and predicted beams so that the UE 206 may better identify the to-be-predicted beams based on the association information provided during the beam prediction configuration for effective and efficient communication with the base station. Particularly, the association information depends on the conditions that whether the set of to-be-predicted i.e, set A beams have been transmitted earlier from the base station 204 to the UE 206 at least during the model training phase or set A beams are not beamformed from the base station 204 to the UE 206 earlier. Same is explained in the upcoming paragraphs with respect to FIGS. 3 and 4. The association information may include one or more predefined rules in the form of beam-topology identifier which is well known to both UE 206 and base station 204 (e.g. eNB, gNB etc.) before the start of the communication. Further, the beam-topology identifier is communicated from the base station 204 to the UE 206 whenever a new set A of beams is subjected to AI-ML based beam prediction, using RRC or MAC signaling.

In one embodiment, this beam topology identifier may be communicated to the UE from the BS 204 via its transceiver 212 and may be stored in the memory unit 208. Now as and when the need arises, corresponding beam topology identifier may be fetched from the memory unit 208 of the BS 204 in conjunction with the processor 210 and may be transmitted along with the configuration information. In an embodiment, the beam topology identifier may be generated using a pre-trained learning model deployed at the BS 204. In another embodiment, the beam topology identifier may be stored in the form of table in the memory 208 of the base station. This beam topology identifier may be transmitted via the transceiver 212 whenever the processor 210 determines meeting of a predefined logic or criteria. In one of the embodiments, the beam topology identifier may be transmitted to the UE 206 using Radio Resource Control (RRC) signalling. In another embodiment, the beam topology identifier may be transmitted to the UE 206 using Medium Access Control signalling.

The beam topology identifier defining the association between the two sets of beams (SET A-SET B), may be received by the UE 206 via transceiver 216. upon receiving the beam topology identifier, the processor 214 of the UE 206 may be configured to generate a measurement report for the set A beams which may include a L1-RSRP (Layer1-reference signal received power) report. The measurement report when taken along with the beam topology identifier may be used to determine the best set A beams based on the transmitted set B beams.

In an aspect, the UE 206 is further deployed with a learning model 220 within its memory 218, which works in conjunction with the processor 214 to predict the best beams within the determined set A beams to establish communication with the BS 204. In one non-limiting embodiment, the inputs to the learning model 220 may include at least one of the following: only L1-RSRP reports generated by the UE 206 based on the measurement results of the received Reference signals corresponding to set B beams; a combination of L1-RSRP measurement reports and the assistance information (which includes the association information) transmitted by the BS 204 to the UE 206; CIR based on the measurement results of the received Set B beams and L1-RSRP measurement based on Set B and the corresponding Downlink Transmit beam ID and/or Receive beam ID. In the present disclosure, at least one of the generated L1-RSRP reports or the transmitted assistance information 208 may have been used for predicting the best beam within the determined set A of beams, however, it is in no way a limitation to its intended scope and the person skilled in the art may use any of the above inputs solely or in combination to train the learning model 220.

The learning model 220, thereby in conjunction with the processor 214 takes the above defined inputs and generates an output that corresponds to the prediction of the one or more best beams within the determined set A of beams and communicates the predicted one or more best beams 224 to the BS 204 to establish effective and robust communication with it. In one embodiment, along with the prediction of the one or more best beams, the learning model 220 in conjunction with the processor 214 may also yield at least one of the following as outputs: beams IDs of the best predicted beams, predicted L1-RSRP measurement reports of the best predicted beams, beam angles, and any other relevant information as and when it has been configured for the same. In an exemplary scenario, the dynamic formation of Set A is required when beams are dynamically formed by gNB-DU based on UE location. After predicting the set of beams (i.e., dynamic beams) for a UE, the UE 304 forwards the generated measurement reports along with the association information 308 to the learning model 310 which predicts the one or more best beams 312 from the set of predicted beams for communicating with a base station.

Present disclosure covers two different embodiments for efficient beam identification and prediction. The first embodiment recites a scenario where the beam prediction may be carried out when the set of to be predicted beams have been transmitted earlier to the UE at least for the purpose of model training, for predicting one or more best beams, from the set of to-be-predicted beams, for communicating with the BS. The process associated with this said embodiment has been explained in detail in the forthcoming paragraphs in conjunction with FIG. 3 of the present disclosure. The second embodiment recites another scenario where the beam prediction may be carried out when the set of to-be-predicted beams have not been transmitted earlier to the UE for predicting one or more best beams, from the set of predicted beams, for communicating with the BS. The process associated with this said embodiment has been explained in detail in the forthcoming paragraphs in conjunction with FIG. 4 of the present disclosure.

FIG. 3 depicts a flow diagram illustrating (the first embodiment discussed in foregoing paragraph) a communication between the base station 302 and the UE 304 for carrying out beam prediction when the set of beams (set A) have been transmitted earlier to the UE 304 at least for the purpose of model training, for predicting one or more best beams in order to establish communication with the BS 302. The BS 302 in communication with UE 304 such that BS 302 may be configured to transmit a set of beams (set B) to the UE 304. Precisely, the base station 302 transmits reference signal (RS) corresponding to the transmitted beams to the UE and on receiving the RS 306 from the BS, UE 304 may be configured to generate measurement reports of the transmitted beams to assess the network quality and other parameters corresponding to the received RS 306. In one non-limiting embodiment, these measurement reports may include L1-RSRP (Layer 1 Reference Signal Received Power) report to measure the power level of the reference signals received at the physical layer of the UE 304. The higher the RSRP value (closer to 0 dBm), the stronger the received signal which indicates good signal quality and a high probability of a successful communication link between the UE 304 and the Base Station 306. These measurement reports may thereby contribute as a parameter for carrying out the process of best beam prediction as disclosed in the FIG. 2 of the present disclosure. During the configuration of the AI-ML based beam prediction use case, the base station also provides a beam topology identifier to the UE 304. In particular, when the set of predicted beams (set A) have already been transmitted to the UE 304 earlier to the prediction of one or more best beams, from the set A beams, then the BS 302 transmits a set static beams and also provides the association information which includes at least a beam topology identifier to the UE for predicting a set of dynamic beams. In an exemplary embodiment, the transmitted beams are broadcast beams. A person skilled in the art may be aware that the broadcast beams are static in nature and these beams are common for all UEs of a particular cell whereas the predicted beams e.g data beams may be specific to a UE and are dynamic in nature. As the data/predicted beams are specific to UE, these are formed dynamically based on a location of the UE.

The beam topology identifier shared in step 306 defines a unique association between the set of transmitted beams and the set of predicted beams for efficient beam identification and prediction. Said beam topology identifier assists the UE to predict one or more best beams from the set of predicted beams for communicating with a base station. In particular, the unique association between the two sets of beams i.e., transmitted beams (Set B) and predicted beams (Set A) enables the UE 304 to predict the beams i.e., set A beams. In this scenario, the beam topology identifier is configured based on one or more predefined rules between the set of transmitted beams and predicted beams and is communicated by the base station to the UE before starting a communication. These one or more predefined rules are established using association between one or more beam identification related parameters such as beam IDs, a predefined offset in respect of Transmission beam angle, a predefined offset in respect of reception beam angle, a predefined mathematical relation, azimuth angle information, and elevation angle information or any other parameter using which a relationship between the beams (SETA-SET B) can be established.

In an embodiment of the present disclosure, the beam identification related parameter may be beam IDs. In an exemplary scenario, Set A beam IDs may be derived based on Alternative beam IDs of Set B. For example, the Set B beam IDs are 1, 3, 5 etc. then Set A beam IDs may be 2, 4, 6 etc. In another embodiment of the present disclosure, the beam identification related parameter may be a predefined offset in respect of Transmission/Receive beam angle. In an exemplary scenario, the Set A beams may be derived based on an offset of Transmit/Receive (Tx/Rx) beam angle of the Set B beams. For example, the offset in transmit angle may be set as 20 degree and same is communicated by the base station to the UE. Then, the UE may configure itself in such a way that it may predict the Set A beams based on the offset of 20 degree in the transmit angle from the Set B beams. In the similar manner, the offset may be communicated for the Receive beam angle of the Set B beams. In yet another embodiment of the present disclosure, the beam identification related parameter may be a pre-defined mathematical relation. In an exemplary scenario, the Set A beam IDs may be derived based on a mathematical relation with Set B beam Ids. In such cases, the mathematical relation is also pre-defined and known to both the base station and the UE. As the mathematical relation is pre-defined and Set A have been transmitted earlier. So, based on the known mathematical relation with Set B beams, UE may predict the Set A beams.

In still another embodiment, the beam identification related parameter may be either azimuth or elevation angle information. For example, Set A beams may be considered to be 10 degrees offset in azimuth from Set B beams. In such scenario, if Set B beams are 10, 30, 50 degrees in azimuth then Set A beams may be considered as 20, 40, 60 degrees in azimuth. In another example, Set A beams may be considered to be 20 degrees offset in elevation from Set B beams. In such scenario, if Set B beams are 10, 30, 50 degrees in elevation, Set A beams may be considered as 30, 50, 70 degrees in elevation. In another embodiment, the beam angle may be considered in both azimuth and elevation. For example, Set A beams may be considered to be 20 degrees offset in elevation and azimuth from Set B beams. In such scenario, if Set B beams are 10, 30, 50 degrees in elevation and azimuth, then Set A beams may be considered as 30, 50, 70 degrees in elevation and azimuth.

In still another non-limiting embodiment of the present disclosure, Set A is a replica of Set B in either azimuth or elevation. In an exemplary scenario, Set B beams are in azimuth then Set A is a replica in elevation. In another exemplary scenario, if Set B beams are in elevation, then Set A is a replica in azimuth. For example, the azimuth angle information of set B beams may be used for elevation angle information of Set A beams or vice versa. In such scenario, if Set B beams are 10, 30, 50 degrees in elevation, Set A beams may be considered as 10, 30, 50 degrees in azimuth. In alternate scenario, if Set B beams are 30, 50, 70 degrees in azimuth then, Set A beams may be considered as 30, 50, 70 degrees in elevation.

In yet another embodiment of the present disclosure, the beam identification related parameter may be static association between Set B and Set A beam IDs and is pre-defined. For example, the Set B beams is defined as b1, b2, and b3 and the Set A beams is defined as a1 and a2. Such association via static beam IDs are operator configured. Thus, it does not change dynamically. It must be appreciated that the relation or association between beam ids of Set B and Set A is not limited to the one presented in the above embodiments. In an embodiment, more than one beam identification related parameters may be used in combination for the association information e.g., mathematical relation as well as the static mapping between Set A and Set B beams may be provided to the UE to ensure the feasibility of dynamic formation of Set A beams and for prediction. Thus, the beam identification related parameters may not be considered in the limited sense. A person skilled in the domain of wireless communication may appreciate that 3GPP RAN1 may keep on adding to these rules/associations between the Set A beams and the Set B beams, based on the requirement. Accordingly, the association may be communicated from the base station to the UE, whenever required using RRC or MAC signaling. Such kind of establishment of one or more rules using the association between beam identification related parameters helps the base station and UE to effectively identify the beam which both the entities are referring to. Accordingly, efficient beam prediction may be performed at UE end.

FIG. 4 depicts a flow diagram illustrating (the second embodiment discussed in foregoing paragraph of FIG. 2) a communication between the base station 402 and the UE 404 for carrying out beam prediction when the set of predicted beams (set A) have not been transmitted earlier to the UE 404 for predicting one or more best beams to establish communication with the BS 402 The base station 402 at step 406, may transmit indication to the UE, the association between the set of transmitted beams and the set of predicted beams (Set A-Set B) is dynamic to the UE 404. Since the BS 402 has not transmitted the set of predicted beams earlier, thus, in this scenario, the BS 402, in step 408, may instruct the UE 404 to transmit one or more beam identification related parameters to the BS 402. When the UE 404 receives this instruction from the BS 402, the UE 404 may be configured to transmit the one or more beam related parameters in step 410. These one or more beam identification related parameters may include at least one of: 3 db beamwidth, beam boresight direction, positioning information of the UE, azimuth and elevation angle information, and Beam ID information. The one or more beam identification related parameters when shared with the Base station 402 enables the base station to correlate and identify the set of predicted beams (Set A), as shown in step 414.

Further, in step 414, the Base Station 402 may generate a beam topology identifier for further usage. This beam topology identifier based on the established association is dynamic in nature and may depend on the current UE session. In such scenario, the beam topology identifier may be considered as a temporary beam topology identifier that is specific to a UE for a particular session and location. In an embodiment, the Base station 402 transmits this temporary UE-specific beam topology identifier in step 416, to the UE using Radio Resource Control (RRC) signalling. In another embodiment, the Base station 402 transmits this temporary UE-specific beam topology identifier in step 416, to the UE using Medium Access Control (MAC) signalling. Upon receiving the beam topology identifier from the base station in step 416, the UE 404 may use the learning model 418 which utilizes the measurement reports (generated in step 412) and the beam topology identifier received in step 416 to determine one or more best beams from a set of predicted beams for communication with the Base station 402. These predicted best beam IDs may be transmitted to the base station 402, in step 420, for efficient communication. Upon receiving the same, the base station 402, in step 422, may beamform the predicted beams to the UE 404 for communication. Since the predicted beams are not transmitted earlier for the prediction thus, the association may be dynamic in nature and may be formed to provide efficient communication with the UE even if the predicted beams are not beamformed earlier to prediction.

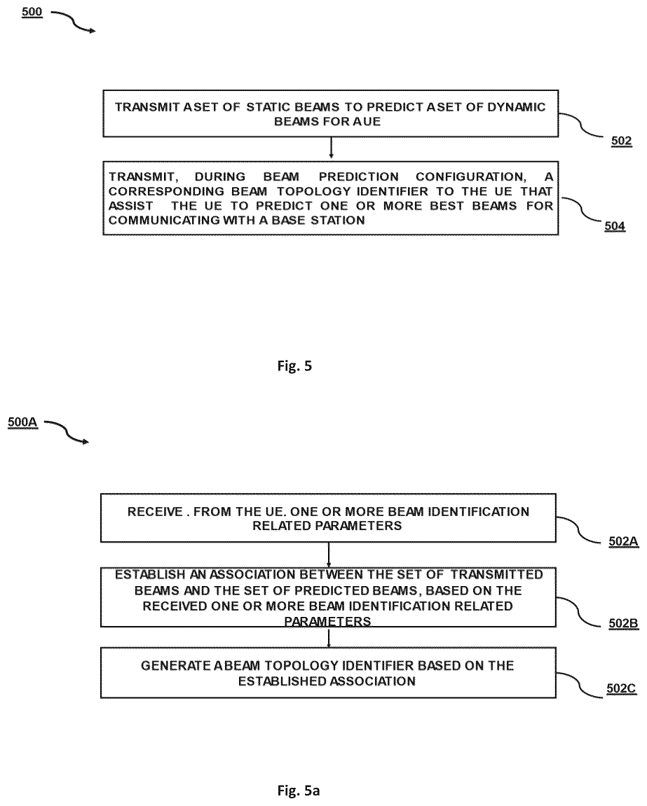

FIG. 5 illustrate a flowchart 500 of an exemplary method for defining association between Set A and Set B for effective beam prediction, in accordance with an embodiment of the present disclosure. Further, FIG. 5a illustrate a flowchart 500a of an exemplary method for defining generation of a beam topology identifier when the set of beams (Set A) beams are not transmitted earlier to prediction to the UE from the base station. The method 500 and 500a may also be described in the general context of computer executable instructions. Generally, computer executable instructions may include routines, programs, objects, components, data structures, procedures, modules, and functions, which perform specific functions or implement specific abstract data types.

The order in which method 500 and 500a are described is not intended to be construed as a limitation, and any number of the described method blocks may be combined in any order to implement the method. Additionally, individual blocks may be deleted from the methods without departing from the spirit and scope of the subject matter described. FIGS. 5 and 5a may work in conjunction with each other when the data beams have not been transmitted earlier to the UE for prediction.

At step 502, the method 500 may include transmitting a set of static beams (set B) to predict a set of dynamic beams (set A) for a UE. The set of predicted beams are formed dynamically based on a location of the UE. In one non-limiting embodiment, the set B beams may or may not be a subset of the set A beams. In another non-limiting embodiment, the set of static beams (set B) may be transmitted via transceiver 212 of the BS 204.

For receiving the predicted beams (set A) based on the transmitted beams (set B) from the UE, base station may transmit the beam topology identifier to the UE. However, transmission of the beam topology identifier depends on two different scenarios. In first scenario, the set of beams i.e. set A have been transmitted earlier to the UE 206. In such scenario, if the set of beams has been transmitted earlier to the UE (i.e, before prediction), then the beam topology identifier is configured based on one or more predefined rules such rules may be established based on the association between beam identification related parameters such as beam IDs, a predefined offset in respect of Transmission beam angle, a predefined offset in respect of reception beam angle, a predefined mathematical relation, azimuth angle information, and elevation angle information etc. A skilled person may appreciate that these rules are non-exhaustive and may be updated based on the 3GPP RAN1 agreement. Same is explained in detail in FIG. 3.

In another scenario, if the set A of beams has not been transmitted earlier to prediction with the UE, then the base station may follow the steps provided in FIG. 5A. For achieving this, the base station may instruct the UE to transmit the beam identification related parameters. In step 502A, the base station receives one or more beam identification related parameters from the UE such as 3 db beamwidth, beam boresight direction, positioning information of the UE, azimuth and elevation angle information, and Beam ID information.

In step 502B, based on these one or more beam identification related parameters, the base station may establish an association between the set of transmitted beams and the set of predicted beams.

In step 502C, the base station generates a beam topology identifier. The beam topology identifier generated in this scenario, where the set A of beams are not transmitted earlier to the UE (i.e, before prediction) is dynamic in nature. In particular, the beam topology identifier may be for a session only and is temporary in nature.

In both the scenarios, the beam topology identifier is shared by the base station to the UE, and it is known to the UE and base station before start of the communication. Particularly, the beam topology identifier is the one that assist the UE, using a well-defined association between the set of transmitted and predicted beams, to predict one or more best beams for communicating with a base station.

At step 504, the method 500 may include transmitting, subsequently (during beam prediction configuration), a corresponding beam topology identifier to the UE 206 that assist the UE to predict one or more best beams from the set of predicted beams (Set A) for communicating with the base station. The beam topology identifier defines a unique association between the set of transmitted beams and the set of predicted beams for efficient beam identification and prediction. In an embodiment, the beam topology identifier is transmitted to the UE using Radio Resource Control (RRC) signalling. In another embodiment, the beam topology identifier is transmitted to the UE using Medium Access Control (MAC) signalling.

The illustrated steps are set out to explain the exemplary embodiments shown, and it should be anticipated that ongoing technological development will change the way particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Suitable processors include, by way of example, a general-purpose processor, a special purpose processor, a conventional processor, a digital signal processor (DSP), a graphic processing unit (GPU), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

### Advantages of the Embodiment of the Present Disclosure are Illustrated Herein—

In an embodiment, the present disclosure provides techniques for defining the association between the set of transmitted beams and set of predicted beams before initiating the AI-ML based beam prediction so that predicted beams at the UE may be identified and predicted correctly.

In an embodiment, the present disclosure provides techniques for improving the beam prediction process and predict the set A beams with the help of association information exchanged between the base station and UE in the form of beam topology identifier, thus enhancing the overall efficiency of the entire wireless network.

Implementation examples are described in the following clauses:

Clause 1: A method comprising: transmitting a set of static beams by a network and based on that, predicting a set of dynamic beams for a UE, wherein the set of predicted beams are formed dynamically based on a location of the UE; and transmitting, during beam prediction configuration, a corresponding beam topology identifier to the UE that assist the UE, using a well-defined association between the set of transmitted and predicted beams, to predict one or more best beams from the set of predicted beams for communicating with a base station, wherein the beam topology identifier defines a unique association between the set of transmitted beams and the set of predicted beams for efficient beam identification and prediction.

Clause 2: The method of clause 1, wherein the transmitted beam topology identifier is configured based on one or more predefined rules between the set of transmitted and predicted beams established between the base station and the UE, if the set of predicted beams have been transmitted earlier to the UE for predicting one or more best beams, for communicating with the base station.

Clause 3: The method of clause 2, wherein the one or more predefined rules are established using association between beam identification related parameters including at least: beam IDs, a predefined offset in respect of Transmission beam angle, a predefined offset in respect of reception beam angle, a predefined mathematical relation, azimuth angle information, and elevation angle information.

Clause 4: The method of clause 1, wherein if the set of predicted beams have not been transmitted earlier to the UE for predicting one or more best beams, the method further comprises: transmitting an indication to the UE that the association between the set of transmitted beams and the set of predicted beams is dynamic; receiving, from the UE, one or more beam identification related parameters, for communicating with the base station; establishing an association between the set of transmitted beams and the set of predicted beams, based on the received one or more beam identification related parameters; and generating a beam topology identifier based on the established association, wherein the generated beam topology identifier is dynamic and is specific to a session established between the base station and the UE.

Clause 5: The method of clause 4, wherein the one or more beam identification related parameters received from the UE include at least one of: 3 db beamwidth, beam boresight direction, positioning information of the UE, azimuth and elevation angle information, and Beam ID information.

Clause 6: The method of clause 1, wherein the beam topology identifier is transmitted to the UE using at least one of: Radio Resource Control (RRC) signaling or Medium Access Control signaling.

Clause 7: The method of clause 1, wherein the set of transmitted beam is broadcast beams and is common for all the UE.

Clause 8: A base station configured to: transmit at least a set of static or broadcast beams by a network and based on that, predicting a set of dynamic beams for a UE, wherein the set of predicted beams are formed dynamically based on a location of the UE; and transmit, subsequently, during beam prediction configuration, a corresponding beam topology identifier to the UE that assist the UE, using a well-defined association between the set of transmitted and predicted beams, to predict one or more best beams from the set of predicted beams for communicating with the base station, wherein the beam topology identifier defines a unique association between the set of transmitted beams and the set of predicted beams for efficient beam identification and prediction.

Clause 9: The base station of clause 8, wherein the transmitted beam topology identifier is configured based on one or more predefined rules between the set of transmitted and predicted beams established between the base station and the UE, if the set of predicted beams have been transmitted earlier to the UE for predicting one or more best beams, from the set of predicted beams, for communicating with the base station.

Clause 10: The base station of clause 9, wherein the one or more predefined rules are established using association between beam identification related parameters including at least: beam IDs, a predefined offset in respect of Transmission beam angle, a predefined offset in respect of reception beam angle, a predefined mathematical relation, azimuth angle information, and elevation angle information or any other parameter using which a relation between beams could be established.

Clause 11: The base station of clause 8, wherein if the set of predicted data beams have not been transmitted earlier to the UE for predicting one or more best beams, the processor is further configured to: transmit an indication to the UE that the association between the set of transmitted beams and the set of predicted beams is dynamic; receive, from the UE, one or more beam identification related parameters, from the set of predicted beams, for communicating with the base station; establish an association between the set of transmitted beams and the set of predicted beams, based on the received one or more beam identification related parameters; and generate a beam topology identifier based on the established association, wherein the generated beam topology identifier is specific to a session established between the base station and the UE.

Clause 12: The base station of clause 11, wherein the one or more beam identification related parameters received from the UE include at least one of: 3 db beamwidth, beam boresight direction, positioning information of the UE, azimuth, and elevation angle information, and BeamID information.

Clause 13: The base station of clause 8, wherein the beam topology identifier is transmitted to the UE using at least one of: Radio Resource Control (RRC) signaling or Medium Access Control (MAC) signaling.

Clause 14: The base station of clause 8, wherein the set of transmitted beam is broadcast beams and is common for all the UE.

Clause 15: A non-transitory computer-readable storage medium storing executable instructions that, in response to execution, cause one or more processors of a base station to perform operations, comprising: transmit a set of static/broadcast beams by a network and based on that, predicting a set of dynamic/data beams for a UE, wherein the set of predicted beams are formed dynamically based on a location of the UE; and transmit, subsequently, during beam prediction configuration, a corresponding beam topology identifier to the UE that assist the UE, using a well-defined association between the set of transmitted and predicted beams, to predict one or more best beams from the set of predicted beams for communicating with a base station, wherein the beam topology identifier defines a unique association between the set of transmitted beams and the set of predicted beams for efficient beam identification and prediction.

Cause 16: The non-transitory computer-readable storage medium of clause 15, wherein the transmitted beam topology identifier is configured based on one or more predefined rules established between the base station and the UE, if the set of data beams have been transmitted earlier to the UE for predicting one or more best beams, from the set of data beams, for communicating with the base station.

Clause 17: The non-transitory computer-readable storage medium of clause 16, wherein the one or more predefined rules are established using association between beam identification related parameters including at least: beam IDs, a predefined offset in respect of Transmission beam angle, a predefined offset in respect of reception beam angle, a predefined mathematical relation, azimuth angle information, and elevation angle information.

Clause 18: The non-transitory computer-readable storage medium of clause 15, wherein if the set of predicted data beams have not been transmitted earlier to the UE for predicting one or more best beams, the operation further comprises: transmitting an indication to the UE that the association between the set of transmitted beams and the set of predicted beams is dynamic; receiving, from the UE, one or more beam identification related parameters, for communicating with the base station; establishing an association between the set of transmitted beams and the set of predicted beams, based on the received one or more parameters; and generating a UE-specific beam topology identifier based on the established association, wherein the generated beam topology identifier is specific to a session established between the base station and the UE.

Clause 19: The non-transitory computer-readable storage medium of clause 18, wherein the one or more beam identification related parameters received from the UE include at least one of: 3 db beamwidth, beam boresight direction, positioning information of the UE, azimuth and elevation angle information, and Beam ID information.

Clause 20: The non-transitory computer-readable storage medium of clause 15, wherein the beam topology identifier is transmitted to the UE using at least one of: Radio Resource Control (RRC) signaling or Medium Access Control (MAC) signaling.

I/We claim:

1. A method comprising:
transmitting a set of static beams by a network and based on that, predicting a set of dynamic beams for a UE, wherein the set of predicted beams are formed dynamically based on a location of the UE; and
transmitting during beam prediction configuration, a corresponding beam topology identifier to the UE that assist the UE, using a well-defined association between the set of transmitted and predicted beams, to predict one or more best beams from the set of predicted beams for communicating with a base station, wherein the beam topology identifier defines a unique association between the set of transmitted beams and the set of predicted beams for efficient beam identification and prediction.

2. The method of claim 1, wherein the transmitted beam topology identifier is configured based on one or more predefined rules between the set of transmitted and predicted beams established between the base station and the UE, if the set of predicted beams have been transmitted earlier to the UE for predicting one or more best beams, for communicating with the base station.

3. The method of claim 2, wherein the one or more predefined rules are established using association between beam identification related parameters including at least: beam IDs, a predefined offset in respect of Transmission beam angle, a predefined offset in respect of reception beam angle, a predefined mathematical relation, azimuth angle information, and elevation angle information.

4. The method of claim 1, wherein if the set of predicted beams have not been transmitted earlier to the UE for predicting one or more best beams, the method further comprises:
transmitting an indication to the UE that the association between the set of transmitted beams and the set of predicted beams is dynamic;
receiving, from the UE, one or more beam identification related parameters, for communicating with the base station;
establishing an association between the set of transmitted beams and the set of predicted beams, based on the received one or more beam identification related parameters; and
generating a beam topology identifier based on the established association, wherein the generated beam topology identifier is specific to a session established between the base station and the UE.

5. The method of claim 4, wherein the one or more beam identification related parameters received from the UE include at least one of: 3 db beamwidth, beam boresight direction, positioning information of the UE, azimuth and elevation angle information, and Beam ID information.

6. The method of claim 1, wherein the beam topology identifier is transmitted to the UE using at least one of: Radio Resource Control (RRC) signaling or Medium Access Control signaling.

7. The method of claim 1, wherein the set of transmitted beam is broadcast beams and is common for all the UE.

8. A base station configured to:
transmit at least a set of static beams by a network and based on that, predicting a set of dynamic beams for a UE, wherein the set of predicted beams are formed dynamically based on a location of the UE; and
transmit during the beam prediction configuration, a corresponding beam topology identifier to the UE that assist the UE, using a well-defined association between the set of transmitted and predicted beams, to predict one or more best beams from the set of predicted beams for communicating with the base station, wherein the beam topology identifier defines a unique association between the set of transmitted beams and the set of predicted beams for efficient beam identification and prediction.

9. The base station of claim 8, wherein the transmitted beam topology identifier is configured based on one or more predefined rules between the set of transmitted and predicted beams established between the base station and the UE, if the set of predicted beams have been transmitted earlier to the UE for predicting one or more best beams, from the set of data beams, for communicating with the base station.

10. The base station of claim 9, wherein the one or more predefined rules are established using association between beam identification related parameters including at least:
beam IDs, a predefined offset in respect of Transmission beam angle, a predefined offset in respect of reception beam angle, a predefined mathematical relation, azimuth angle information, and elevation angle information.

11. The base station of claim 8, wherein if the set of predicted data beams have not been transmitted earlier to the UE for predicting one or more best beams, the processor is further configured to:
transmit an indication to the UE that the association between the set of transmitted beams and the set of predicted beams is dynamic;
receive, from the UE, one or more beam identification related parameters for communicating with the base station;
establish an association between the set of transmitted beams and the set of predicted beams, based on the received one or more beam identification related parameters; and
generate a beam topology identifier based on the established association, wherein the generated beam topology identifier is specific to a session established between the base station and the UE.

12. The base station of claim 11, wherein the one or more beam identification related parameters received from the UE include at least one of: 3 db beamwidth, beam boresight direction, positioning information of the UE, azimuth, and elevation angle information, and BeamID information.

13. The base station of claim 8, wherein the beam topology identifier is transmitted to the UE using at least one of: Radio Resource Control (RRC) signaling or Medium Access Control (MAC) signaling.

14. The base station of claim 8, wherein the set of transmitted beams is broadcast beams and is common for all the UE.

15. A non-transitory computer-readable storage medium storing executable instructions that, in response to execution, cause one or more processors of a base station to perform operations, comprising:
transmit a set of static beams by a network and based on that, predicting a set of dynamic beams for a UE, wherein the set of predicted beams are formed dynamically based on a location of the UE; and
transmit, subsequently, a corresponding beam topology identifier to the UE that assist the UE, using a well-defined association between the set of transmitted and predicted beams, to predict one or more best beams from the set of predicted beams for communicating with a base station, wherein the beam topology identifier defines a unique association between the set of transmitted beams and the set of predicted beams for efficient beam identification and prediction.

16. The non-transitory computer-readable storage medium of claim 15, wherein the transmitted beam topology identifier is configured based on one or more predefined rules established between the base station and the UE, if the set of data beams have been transmitted earlier to the UE for predicting one or more best beams for communicating with the base station.

17. The non-transitory computer-readable storage medium of claim 16, wherein the one or more predefined rules are established using association between beam identification related parameters including at least: beam IDs, a predefined offset in respect of Transmission beam angle, a predefined offset in respect of reception beam angle, a predefined mathematical relation, azimuth angle information, and elevation angle information.

18. The non-transitory computer-readable storage medium of claim 15, wherein if the set of predicted beams have not been transmitted earlier to the UE for predicting one or more best beams, the operation further comprises:
transmitting an indication to the UE that the association between the set of transmitted beams and the set of predicted beams is dynamic;
receiving, from the UE, one or more beam identification related parameters for communicating with the base station;
establishing an association between the set of transmitted beams and the set of predicted beams, based on the received one or more parameters; and
generating a UE-specific beam topology identifier based on the established association, wherein the generated beam topology identifier is specific to a session established between the base station and the UE.

19. The non-transitory computer-readable storage medium of claim 18, wherein the one or more beam identification related parameters received from the UE include at least one of: 3 db beamwidth, beam boresight direction, positioning information of the UE, azimuth and elevation angle information, and Beam ID information.

20. The non-transitory computer-readable storage medium of claim 15, wherein the beam topology identifier is transmitted to the UE using at least one of: Radio Resource Control (RRC) signaling or Medium Access Control (MAC) signaling.
